(19) United States
(12) Patent Application Publication
(10) Pub. No.: US 2023/0339731 A1
(43) Pub. Date: Oct. 26, 2023

(54) TOWER CRANE

(71) Applicant: Liebherr-Werk Biberach GmbH, Biberach an der Riss (DE)

(72) Inventors: Michael EGGERT, Biberach an der Riss (DE); Martin ASSFALG, Attenweiler (DE)

(21) Appl. No.: 18/308,231

(22) Filed: Apr. 27, 2023

Related U.S. Application Data
(63) Continuation of application No. PCT/EP2021/079326, filed on Oct. 22, 2021.

(30) Foreign Application Priority Data
Oct. 27, 2020 (DE) 10 2020 128 161.7

(51) Int. Cl. B66C 23/88; B66C 23/16; B66C 23/30; B66C 23/36

(52) U.S. Cl. CPC B66C 23/88; B66C 23/16; B66C 23/30; B66C 23/36; B66C 2700/0371

(57) ABSTRACT

The invention relates to a tower crane having a tower which carries a jib, from which a hoisting cable runs off, wherein a guying system is provided and runs, at least in part, along the tower and is spread out, by means of guy supports, in a direction transverse to the longitudinal center plane of the crane, this plane running through the tower and the jib, wherein at least one pair of guy supports which are spread out in a V-shaped manner are articulated on the tower, between the lower end of the latter and the jib.

### CROSS-REFERENCE TO RELATED APPLICATIONS

This application is a continuation of International Patent Application Number PCT/EP2021/079326 filed Oct. 22, 2021, which claims priority to German Patent Application Number DE 10 2020 128 161.7 filed Oct. 27, 2020, the contents of which are incorporated herein by reference in their entireties.

### BACKGROUND

The present invention relates to a tower crane having a tower which carries a jib, from which a hoisting cable runs off, wherein a guying system is provided and runs, at least in part, along the tower and is spread out, by means of guy supports, in a direction transverse to the longitudinal center plane of the crane.

In order to be able to receive high loads in tower cranes with relatively large outreach, i.e. large jib lengths, there is known the guying of the jib, wherein usually one, two or also three guy ropes or rods are led to the jib from a tower top projecting above the jib or from guy supports projecting from a jib articulation piece and are articulated there.

If there is a counterjib that carries the ballast weight, the guying system is usually led to the rear of this counterjib. In the case of tower cranes without a counterjib, the guying system is led downwardly via the then rearwardly inclined tower top or guy brace.

The bracing tension means in the form of guy ropes, guy rods or occasionally guy chains in this respect usually run through the longitudinal center plane of the crane, which runs through the tower and the jib, in order to absorb the vertical loads and the bending and overturning moment induced by them and acting in the longitudinal center plane of the crane, the vertical loads originating to a large extent from the suspended hoisting load, but also including dead load components of the jib. This can prevent or at least limit excessive deflection of the jib in said longitudinal center plane of the crane.

However, the stability and thus the load capacity of the crane is also limited by twisting of the crane structure transverse to the longitudinal center plane of the crane, wherein transverse loads transverse to the longitudinal center plane of the crane are substantially introduced into the crane structure by laterally acting wind, but pendulum loads or rotational accelerations with attached loads can also induce transverse forces in the jib when the crane rotates about the upright tower axis.

In order to prevent the jib from twisting in a direction transverse to the longitudinal center plane of the crane or to stiffen the jib against transverse forces, but at the same time to reach a guying system against the mainly acting vertical loads, it has already been suggested to spatially spread out the jib and to guide the guy ropes over guy supports spread out in a V-shaped manner, which are mounted on the back of the jib. For example, DE 31 05 771 A1 shows a tower crane with a telescopic tower carrying a jib on the top of which guy supports are spread out in a V-shaped manner. Two guy ropes run over the projecting ends of the guy supports, which are spread out in a V-shaped manner, and are brought together at a guy support projecting horizontally backwards from the tower's jig articulation piece, from which a guy rope is then led down in the longitudinal center plane of the crane to the revolving platform, where it is attached to the ballast carrier. This spatial guying system of the jib via guy supports spread out in a V-shaped manner prevents bulging or lateral twisting of the jib. At the same time, it becomes possible to straighten the jib, so to speak, by precisely adjusting the length of the two guy ropes.

On the other hand, it has already been suggested that the guying system descending along the tower be moved out of the longitudinal center plane of the crane and that right and left guy ropes be provided, as it were, which are attached on the one hand to the top of the tower's articulation piece or to an upper revolving platform provided there and on the other hand to the lower revolving platform below, which rotates the tower. For example, DE 10 2013 011 489 A1 shows a guying system in which lattice pieces are bolted to the lower revolving platform, extending perpendicularly from the side surface of the revolving platform and in a direction transverse to the load direction. At the respective outer end of the bolted lattice pieces, bracing tension means are bolted on, which run through to bracing winches on the upper fixed revolving platform.

Despite the guying system running down along the tower, the tower remains at risk of twisting laterally in a direction transverse to the longitudinal center plane of the crane under transverse loads, such as stronger crosswinds, wherein the tower is not only loaded like a bending beam but is also subject to increased buckling loads due to the additional high vertical loads acting on the tower in the manner of a compression beam. The susceptibility to buckling is known to be further aggravated when an elongated, slender bar profile has already undergone a certain amount of bending in addition to the compressive load due to transverse forces. Such losses of stability of rod-like structures due to lateral deflection under axial compressive loading are sometimes referred to as the Euler buckling cases.

To increase the stability of the crane structure, the jib and tower cross portions are usually enlarged and/or the wall thicknesses of the portion parts are increased or, in the case of truss structures, the cross bracing is also reinforced. However, this leads to a reduction in efficiency, i.e. the ratio of the load that can be lifted by the crane to the crane's own weight. In addition, the increased crane weight also affects assembly handling and compliance with the permissible road transport weights is impaired.

### SUMMARY

It is the underlying object of the present invention to provide an improved tower crane of the initially named kind which avoids disadvantages of the prior art and further develops the latter in an advantageous manner. In particular, the aim is to achieve increased stability of the crane structure and thus safety in crane operation in the event of laterally acting forces such as crosswinds without deterioration or preferably with simultaneous improvement of the efficiency, i.e. the ratio of the load capacity to the crane's own weight.

Said task is solved, according to the invention, with a tower crane as claimed in claim 1. Preferred embodiments of the invention are the subject-matter of the dependent claims.

It is therefore proposed to support the tower via the guying system also between its ends against transverse loads or buckling via the guying system. According to the invention, the guying system comprises at least one pair of guy supports spread out spatially and articulated on the tower between the lower end of the latter and the jib. The spread out guy supports on the tower allow compression and/or tension forces with a component perpendicular to the longitudinal center plane of the crane to be transmitted between the tower and the guying system, stabilizing the tower against bulging or buckling. In particular, the guy supports transmit tensile and/or compressive forces from the tower to the guy means running along the tower, which may be configured, for example, in the form of guy cables, guy rods or guy chains, transverse to the longitudinal center plane of the tower, wherein the transmitted tensile and/or compressive forces of advantageous components may be both in a direction transverse to the longitudinal center plane of the crane and parallel to the longitudinal center plane of the crane.

In an advantageous further development of the invention, two or more pairs of guy supports spread out in a V-shaped manner can be articulated on the tower in a distributed manner along the tower and support different tower portions in a lying position at different heights against transverse forces or buckling of the tower profile.

In this respect, the guy supports, spread out in a V-shaped manner, can be configured in various ways, in particular comprising elongated beams inclined at an acute angle to one another, which run through in an approximately straight line but can also be curved or bent.

However, the guy supports can also be configured in the form of a frame profile-type guying frame. In this respect, the V-shaped manner of spreading out is defined by the articulation points of the guy ropes or the bracing tension means on the guy supports or the guying frame on the one hand and the articulation points of the guy supports or the guying frame on the tower on the other hand, whereby optionally only one common articulation point can be provided on the tower. In this respect, the guy supports may also form part of a guying frame or a guy support structure running in a direction transverse to the guy ropes.

In an advantageous further embodiment of the invention, at least one pair of guy supports may be articulated on a jig articulation piece of the tower on which the jib is articulated, and at least one other pair of guy supports may be articulated on an intermediate tower portion provided between the lower tower end portion and said jib articulation piece to, on the one hand, restrain the heavily loaded jig articulation piece against lateral twisting and transverse forces and, on the other hand, restrain the tower at the intermediate portion against buckling or lateral deformation.

Advantageously, said two pairs of guy supports on the jig articulation piece and on the intermediate tower portion spatially brace the bracing tension means in such a way that the jig articulation piece and the intermediate tower portion are braced both against transverse forces and deformations in a direction transverse to the longitudinal center plane of the crane and against longitudinal forces and deformations parallel to the longitudinal center plane of the crane.

In particular, a lower pair of guy supports spread out in a V-shaped manner may be articulated on the tower in a lower third of the tower, for example in the range of 10% to 50% of the tower height when measured from below the tower base.

Alternatively or additionally, a pair of guy supports spread out in a V-shaped manner may be articulated on the tower at an intermediate tower portion at a height in the range of 30% to 60% or 40% to 70% of the tower height, the tower height meaning the vertical extent of the tower from its lower end to the height of the articulation point of the jib on the tower, and a possibly provided tower top not being included in the measurement.

In an advantageous further embodiment of the invention, the bracing tension means along the tower can be guided in a bracing plane extending upright and perpendicular to the longitudinal center plane of the crane and arranged at a distance from the tower on a rear side of the tower facing away from the jib. The bracing tension means are thus arranged offset from the tower towards the rear and at the same time spaced from each other in a direction transverse to the longitudinal center plane of the crane, so that the guying system can receive both longitudinal forces in the longitudinal center plane of the crane and transverse forces along the tower.

In particular, the bracing tension means may pass substantially straight past the at least one pair of spatially spread out guy supports articulated on the tower between the lower end thereof and the jib articulation piece on the tower or may be only slightly bent at the guy supports, for example at a bend angle in the range 160° to 180° or 170° to 180°. Due to such a geometry or guidance of the bracing tension means, transverse forces or tensile and/or compressive forces between the tower and the bracing tension means are substantially only transmitted via the guy supports when transverse forces act on the tower, for example in the form of crosswinds, or when the tower is in danger of buckling or bulging. Normally, when there are no major external wind loads or other lateral forces acting on the tower or the jib, the bracing tension means, which are strongly tensioned in the direction of pull, do not cause any pre-tensioning on the tower, but pull straight past the guy supports, so to speak, which are articulated on the tower. This deems at least a lower pair of guy supports or a pair of guy supports articulated on the intermediate tower portion. A pair of guy supports attached to the upper end of the tower or to the jig articulation piece can provide a stronger deflection of the bracing tension means to redirect them towards the jib.

In an advantageous further development of the invention, the bracing tension means with their lower ends can be articulated on a revolving and/or supporting platform of the tower crane supporting the tower, wherein the articulation points on the revolving and/or supporting platform can be substantially situated perpendicularly below the articulation points of the guy supports for the bracing tension means.

At a minimum, the pair of guy supports may have at least one configuration in which the articulation points of the bracing tension means on the revolving and/or supporting platform are substantially perpendicular below the articulation points on the guy supports. In another configuration, which can be obtained by adjusting the guy supports and/or adjusting the articulation points of the bracing tension means, the articulation points on the revolving or supporting platform can be offset with respect to perpendiculars by the articulation points on the guy supports.

In order to be able to brace the crane structure more strongly against vertical loads or forces in the longitudinal center plane of the crane or to brace it more strongly against transverse forces such as wind loads, or to be able to variably adjust the ratio of the guying system in the longitudinal and transverse directions, depending on the different conditions of use, an adjustment apparatus for variably adjusting and determining a spread angle of the guy supports can be provided in an advantageous further development of the invention. If the spread angle is increased, the distance between the bracing tension means, i.e. in a direction transverse to the longitudinal center plane of the crane, is increased and the bracing effect against transverse forces or transverse deformations in a direction transverse to the longitudinal center plane of the crane is increased. Conversely, if the spread angle is reduced, the bracing effect in the longitudinal center plane of the crane is increased or the shear force bracing is reduced.

As already mentioned above, the said spread angle means the spread of two imaginary straight lines which pass through the articulation point of the bracing tension means on the guy support on the one hand and the articulation point of the guy support on the tower on the other hand, and is in this respect regardless of the specific contouring of the guy supports or the guying frame. In this respect, the adjustment apparatus can also be configured differently.

If, for example, two separate guy supports are articulated on the tower, for example in the form of elongated beams, a spreading drive or said adjustment apparatus may comprise a pivoting device for pivoting the two guy supports more or less apart or more towards each other. If, however, a frame-like guying frame is provided which may, for example, comprise a cross member between the articulation points of the bracing tension means, for example, telescopic cross members may be provided and the spreading drive may comprise a telescoping drive in order to spread the guy ropes further apart by lengthening the cross member and, conversely, to bring them closer together by shortening the cross member.

In this respect, the said spreading drive can be externally powered, for example comprising a hydraulic cylinder or having a spindle drive. Alternatively or additionally, a manually operated spreading drive can be provided, for example, to set a desired spread angle before the crane is erected.

Alternatively or in addition to an adjustability of the spread angle, an adjustment apparatus for adjusting and variably determining an effective length of the guy supports can be provided to change the run through of the bracing tension means by adjusting the effective length of the guy supports. For example, telescopic guy supports can be provided, whereby a telescoping drive can advantageously be provided in order to be able to telescope out and/or telescope in the guy supports with external energy drive, which also enables convenient adjustment even when the crane is already assembled or erected, e.g. if an operating day with stronger crosswinds is pending. Alternatively, however, it may be sufficient to provide a manually operated length adjustment device, for example a spindle drive or a screw connection between two support beam parts, in order to be able to adjust the effective length of the guy supports, for example during crane assembly. Said effective length means the distance between the articulation point of the bracing tension means on the guy support and the articulation point on the tower.

In an advantageous further development of the invention, the guying system is led spatially in a spread out manner across the interface between the tower and the jib, wherein the guying system can be spatially spread out both along the tower and along the jib in a direction transverse to the longitudinal center plane of the crane. Such spatial bracing across the tower-boom interface can stiffen or brace the entire crane structure, including tower and boom, against lateral forces and also prevent or limit lateral deflection movements of the boom. This allows a significantly increased load capacity to be reached without noticeably increasing the crane's dead weight.

### BRIEF DESCRIPTION OF THE DRAWINGS

The invention is explained in more detail below on the basis of a preferred exemplary embodiment and the corresponding drawings. The drawings show:

FIG. 1 a side view of a tower crane with a guying system bracing the tower and the jib;

FIG. 2 a rear view of the tower crane of FIG. 1 showing the spreading out of the guying system in a direction transverse to the longitudinal center plane of the crane and the effective lever arm of the bracing tension means along the tower transverse to the longitudinal center plane of the crane; and

FIG. 3 a top view of the tower crane showing the spatial run through of the bracing tension means along the jib and tower.

### DETAILED DESCRIPTION

As shown in the figures, the tower crane 1 includes a tower 2 that is upright in operation and supports a jib 3 that is articulated on an upper end portion of the tower 2 and projecting from the tower 2.

A hoisting cable 4 runs from the jib 3 in order to be able to raise and lower a load handling device such as a load hook. Said hoisting cable 4 can run from a trolley 5, which can be moved along the jib 3 by a trolley drive. Alternatively, however, it would also be possible to allow the hoisting cable 4 to run off a jib tip, in particular if the jib 3 can be luffed up, although a trolley 5 can also be provided if the jib 3 can be luffed up. The jib 3 can be oriented in a lying position in at least one operating position.

The tower 2 is mounted on a revolving and/or supporting platform 6 that can be rotated about an upright axis of rotation by a slewing gear, so that the entire crane can be rotated about the upright axis of rotation, which may be coaxial with the longitudinal axis of the tower. As an alternative to such a bottom-slewer, however, the tower crane 1 can also be configured as a top-slewer, in which case the jib 3 is mounted on the tower 2 so as to rotate about the upright axis. The guying system 7, which is still to be described, can be articulated on the overhead revolving platform for the jib in such a top rotator.

As the figures show, the tower 2 and the jib 3 are braced by a guying system 7 comprising bracing tension means 8 running along the jib 3 and along the tower 2, which may be configured in the form of guy ropes, guy rods or, as the case may be, guy chains or even mixed forms thereof.

As shown in the figures, the bracing tension means 8 may have one or more articulation points on the jib 3, for example articulated in an outer half or third of the jib 3 to extend above the back of the jib 3 back toward the tower 2.

The bracing tension means 8 can in this respect be braced by one or more guy supports 9 on the jib 3, for example by means of a guy support between the outer attachment point of the bracing tension means 8 and the tower 2 and a further guy support 9 in the area of the jib articulation piece with which the jib 3 is articulated on the tower 2.

Advantageously, said guy supports 9 are configured in the form of spatial spread out guy frames or in the form of pairs of guy supports spread out in a V-shaped manner so that the bracing tension means 8 are guided over the jib 3 in a direction transverse to the longitudinal center plane 10 of the tower crane 1, which runs through its tower 2 and its jib 3, spaced apart from each other. In this respect, the guy supports 9 can be spread out to such an extent that the bracing tension means 8 are spaced further apart above the jib 3, at least in sections, than the jib 3 is wide. In particular in the area of the inner half or an inner third of the jib 3, i.e. the half or the third closer to the tower 2, the distance of the bracing tension means 8 from each other may be greater than the transverse extension of the jib 3 in a direction transverse to said longitudinal center plane 10.

The said guy supports 9 on the jib 3 may be spread out in an upward V-shaped manner, for example at an angle of 2 times 10° to 2 times 60° or 2 times 15° to 2 times 40° or 2 times 10° to 2 times 20°. In this respect, the guy supports 9 are inclined symmetrically to the longitudinal center plane 10.

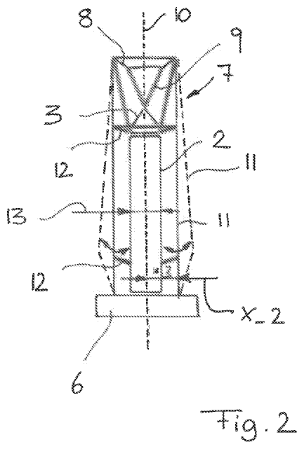

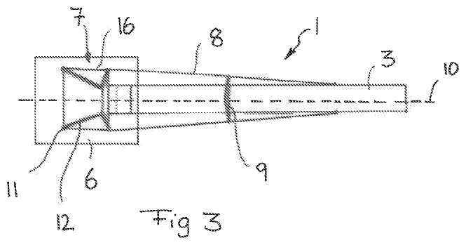

The guying system 7 also comprises bracing tension means 11 running through the tower 2 from top to bottom, which are supported on the tower 2 by means of guy supports 12. As FIG. 2 and FIG. 3 show, the bracing tension means 11 are also spread out or spaced apart along the tower 2 both along the longitudinal center plane 10 of the tower crane 1 in order to be able to absorb both transverse forces transverse to the longitudinal center plane 10 and longitudinal forces in the longitudinal center plane 10.

In this respect, the bracing tension means 11 are supported on the tower 2 by means of several pairs of guy supports 12 in order to be able to transmit tensile and/or compressive forces between the tower 2 and the bracing tension means 11.

In this respect, the pairs of guy supports 12 are spread out in a V-shaped manner and are arranged symmetrically with respect to the longitudinal center plane 10, with the guy supports 12 extending to the rear side of the tower 2 facing away from the jib 3.

As FIG. 2 and FIG. 3 show, the spread angle β of the guy supports 12 may be such that the distance of the bracing tension means 11 from each other or in a direction transverse to the longitudinal center plane 10 is greater than the transverse extent of the tower transverse to said longitudinal center plane 10. The guy supports 12 may be spread out in a V-shaped manner rearwardly from the tower 2, for example at an angle β of 2 times 10° to 2 times 60°, or 2 times 15° to 2 times 40°, or 2 times 10° to 2 times 20°.

In FIG. 2, the distance of the bracing tension means 11 from the longitudinal center plane 10 is denoted by the dimension X_2, which indicates the effective lever arm of the bracing tension means 11 with respect to the longitudinal center plane or is a measure of the guying system of transverse loads. The spacing X_2 of the bracing tension means transverse to the longitudinal center plane 10 may vary and be, for example, in the range of 60% to 500% or 75% to 300% or 100% to 200% of the width 13 of the tower 2, i.e., its extension in a direction transverse to the longitudinal center plane 10.

However, depending on how wide the tower 2 is configured, the spacing of the bracing tension means 11 from the longitudinal center plane 10 may be in other ranges. Advantageously, the spacing can be selected at least so large that the bracing tension means 11 span a larger bracing width than the tower 2 is wide. For example, the bracing tension means 11 can span a bracing width of 2 times X_2 in the area of the tower 2, which is approximately twice the width of the tower 2 when the crane 1 is viewed from its rear side in accordance with FIG. 2.

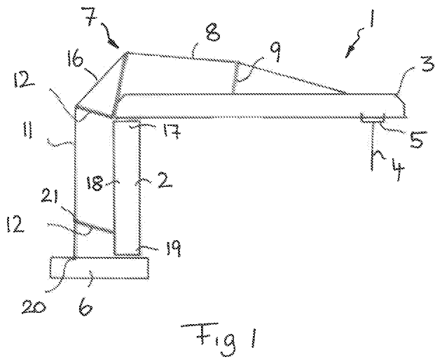

As FIG. 1 shows, the bracing tension means 11 may run through along the tower 2 in a bracing plane 14 extending upright and perpendicular to the longitudinal center plane 10, said bracing plane 14 advantageously being at least approximately vertical in orientation.

In this respect, the bracing plane 14 is arranged at a distance from the tower 2 on its rear side, i.e. opposite the jib 3, so that the bracing tension means 11 can also transfer loads in the longitudinal center plane 10 and brace the tower against vertical loads.

As FIG. 3 shows, the spread angle β realized by the guy supports 12 articulated on the tower 2 can be in the range of 2 times 5° to 2 times 60° or 2 times 10° to 2 times 50° or 2 times 15° to 2 times 40°, said spread angle β being defined by the connecting straight lines passing on the one hand through the articulation points of the bracing tension means 11 to the guy supports 12 and on the other hand through the articulation points of the guy supports 12 to the tower 2.

Advantageously, the guy supports 12 can be variably adjustable with regard to the spread angle β, whereby an adjustment apparatus 15 can comprise, for example, a hydraulic cylinder or a spindle drive which is arranged between the guy supports 12 belonging together in pairs and acts on the two guy supports 12 in order to spread them further apart or spread them open less. This spreading out of the guy supports 12 is shown in FIG. 2, where the course of the bracing tension means 11 when the guy supports 12 are spread out further is shown by the dashed lines, while the solid lines show the course of the bracing tension means when they are spread out less.

Alternatively or in addition to an adjustability of the spread angle β, the guy supports 12 can also be configured to be variable in length, for example telescopic, and as the case may be have a telescoping drive in order to be able to variably adjust the run through of the spatial guying system 7 along the tower 2 also by changing the length of the guy supports 12.

The adjustability of the run through of the spatial guying system 7 along the tower 2 allows the guying system to be adapted to the conditions of use. If the crane is used in strong crosswind conditions, for example, the bracing tension means 11 along the tower 2 and/or along the jib 3 can be spaced further apart from each other by spreading out the guy supports and/or the guy supports 9 more or by extending the guy supports in order to have a greater lever arm effect with respect to transverse forces or transverse loads on the crane structure or to be able to brace stronger transverse loads. However, if the crane is used when there is no wind and/or is subjected to very high loads that require maximum guying in the longitudinal center plane 10, it may be advantageous to move the guy supports 12 further together or to move the bracing tension means 11 and/or the bracing tension means 8 less in a direction transverse to each other.

As the figures show, the bracing tension means 11 run approximately straight past the lower guy supports 12, which may be provided in the lower third of the tower 2, or they are bent only slightly depending on the angle of spread of the guy supports 12. In particular, the articulation points of the bracing tension means 11 on the revolving and/or supporting platform can be set substantially perpendicularly below the articulation points of the guy supports 12 for the bracing tension means 11, so that the bracing tension means 11 run substantially straight or perpendicularly downward from the guy supports 12 to the revolving and/or supporting platform 6.

As FIG. 1 illustrates, the guying system 7 is led beyond spatially across the interface between the tower 2 and the jib 3. Bracing tension means 16 can connect the bracing tension means 11 running along the tower 2 to the bracing tension means 8 running above the jib 3 and/or can run through from the articulation points of the upper tower bracing supports 12 to the articulation points of inner jib bracing supports 9 or connect them to each other.

We claim:

1. A tower crane comprises:
a tower which carries a jib, from which a hoisting cable runs off,
a guying system, wherein the guying system runs, at least in part, along the tower and is spread out by guy supports transverse to a longitudinal center plane of the crane, wherein the longitudinal center plane runs through the tower and the jib, wherein at least one pair of the guy supports are spread out in a V-shaped manner and are articulated on the tower between the lower end of the latter and the jib.

2. The tower crane of claim 1, wherein two or more pairs of the guy supports which are spread out in a V-shaped manner are articulated on the tower in a distributed manner along the tower and project rearwardly from the tower in a lying position toward the rear side facing away from the jib.

3. The tower crane of claim 1, wherein at least one pair of spread out guy supports is articulated on an upper jib articulation part of the tower on which the jib is articulated, and wherein at least another pair of guy supports is articulated on an intermediate tower portion between a lower tower end portion and the jib articulation part.

4. The tower crane of claim 3, wherein the at least another pair of guy supports is articulated on the tower in a lower third of the tower.

5. The tower crane of claim 1, further comprising bracing tensioners guided along the tower in a bracing plane extending upright and perpendicular to the longitudinal center plane of the crane and arranged at a distance from the tower on a tower rear side facing away from the jib.

6. The tower crane of claim 1, further comprising bracing tensioners that run substantially straight past the at least one pair of guy supports which are spread out in a V-shaped manner and which are articulated on the tower between the lower end of the latter and the jib, or have a bend angle on said at least one pair of guy supports in the range of 160° to 180°.

7. The tower crane of claim 1, further comprising bracing tensioners that are articulated with the lower ends of the bracing tensioners on a revolving and/or supporting platform supporting the tower, and wherein first articulation points are arranged on the revolving and/or supporting platform substantially vertically below second articulation points of the guy supports for the bracing tensioners.

8. The tower crane of claim 1, further comprising an adjustment apparatus for variably adjusting and determining a spread angle β of the at least one pair of guy supports articulated on the tower.

9. The tower crane of claim 8, wherein the adjustment apparatus comprises a spreading drive comprising a hydraulic cylinder or a spindle drive for motorized spreading out of the guy supports.

10. The tower crane of claim 9, wherein the adjustment apparatus has an adjustment area for the spread angle β in the range of 2 times 10° to 2 times 60°.

11. The tower crane of claim 9, wherein the adjustment apparatus has an adjustment area for the spread angle β in the range of 2 times 15° to 2 times 30°.

12. The tower crane of claim 7, wherein the adjustment apparatus has an adjustment area for the spread angle β in the range of 2 times 10° to 2 times 60°.

13. The tower crane of claim 7, wherein the adjustment apparatus has an adjustment area for the spread angle β in the range of 2 times 15° to 2 times 30°.

14. A tower crane of claim 1, comprising an adjustment apparatus for adjusting and variably determining a length of the guy supports, wherein the guy supports are telescopic.

15. The tower crane of claim 1, wherein the guying system is led beyond the interface between the tower and the jib in a spatially spread-out manner and is spatially spread out both along the tower and along the jib in a direction transverse to the longitudinal center plane of the crane.

16. The tower crane of claim 1, wherein the tower is configured to be tiltable and/or telescopic and/or the jib is foldable against the tower.

17. A mobile truck crane comprising:
the tower crane of claim 16,
an undercarriage suitable for road transport, wherein the tower and the jib are erectably mounted on the undercarriage.

18. The tower crane of claim 1, further comprising bracing tensioners that have a distance from each other along the tower in a direction transverse to the longitudinal center plane of the crane which is greater than a width of the tower transverse to the longitudinal center plane of the crane, wherein the distance of the bracing tensioners from each other along the tower is from 125% to 500% of the width of the tower transverse to the longitudinal center plane of the crane.

19. The tower crane of claim 1, further comprising bracing tensioners that have a distance from each other along the tower in a direction transverse to the longitudinal center plane of the crane which is greater than a width of the tower transverse to the longitudinal center plane of the crane, wherein the distance of the bracing tensioners from each other along the tower is from 150% to 300% of the width of the tower transverse to the longitudinal center plane of the crane.

20. The tower crane of claim 1, further comprising bracing tensioners that run substantially parallel to each other along the tower.
